(19) United States
(12) Patent Application Publication
(10) Pub. No.: US 2026/0062618 A1
(43) Pub. Date: Mar. 5, 2026

(54) OIL-LIQUEFACTION APPARATUS, AND OlL-LIQUEFACTION METHOD USING SAME

(71) Applicant: Kitahama Chemistry Co., Ltd., Osaka-shi, Osaka (JP)

(72) Inventors: Yasuyuki Akasaka, Osaka-shi (JP); Shin-ichi Murakami, Osaka-shi (JP)

(73) Assignee: Kitahama Chemistry Co., Ltd., Osaka-shi, Osaka (JP)

(21) Appl. No.: 19/104,484

(22) PCT Filed: Aug. 18, 2023
(86) PCT No.: PCT/JP2023/029905

§ 371 Date: Feb. 18, 2025

(30) Foreign Application Priority Data
Aug. 19, 2022 (JP) 2022-130997

(51) Int. Cl. C10B 47/34; C10B 53/07; C10G 1/02

(52) U.S. Cl. CPC C10B 47/34; C10B 53/07; C10G 1/02; C10G 2300/1003

(57) ABSTRACT

The oil-liquefaction apparatus is provided with a thermal cracking furnace and a condenser, in which the thermal cracking furnace is provided with at least a pyrolysis cauldron 21, a heating furnace 22, a stirring device which stirs a material of interest in the pyrolysis cauldron 21, and a discharge section which discharges a thermal cracking gas generated in the pyrolysis cauldron 21 to the condenser. The pyrolysis cauldron 21 has a bottom part 21d which has a bottom surface 21c, an approximately cylindrical intermediate part 21a, and a lid part 25. A heating furnace 22 heats the bottom part 21d and at least the lower part of the intermediate part 21a. The stirring device has an shaft 27 and a blade part 26. The blade part 26 is slidably contacted with the bottom surface 21c and a ring-shaped surface 21b by rotating the shaft 27.

### TECHNICAL FIELD

The present invention relates to an oil-liquefaction apparatus and an oil-liquefaction method using the same, and more particularly to an oil-liquefaction apparatus including a pyrolysis furnace for pyrolyzing an inputted synthetic resin-containing material and a condenser for condensing pyrolysis gas generated in the pyrolysis furnace, the pyrolysis furnace including at least a pyrolysis cauldron for holding the material to be treated, a heating furnace for heating the pyrolysis cauldron from the outside, a stirring device for stirring the material in the pyrolysis cauldron, and a discharge section for discharging the pyrolysis gas generated in the pyrolysis cauldron to the condenser, and an oil-liquefaction method using the same.

### BACKGROUND ART

Conventionally, pyrolysis oil-liquefaction apparatuses such as those described in Patent Documents 1 to 3 have been known. The apparatuses in Patent Documents 1 and 2 have a decomposition vessel for pyrolyzing plastics, a heating chamber for heating the decomposition vessel, a conveying section for conveying the plastics downstream while stirring them in the decomposition vessel, and an outlet for discharging pyrolysis gas, and perform chemical recycling of plastics. In the apparatus in Patent Document 3, a recess is formed in the bottom periphery of the pyrolysis vessel, and pyrolysis residue is discharged from this section.

Recently, materials containing 50% or more of inorganic substances such as calcium carbonate, such as LIMEX (registered trademark), have come to be used as alternative materials to plastics. However, because they contain 50% or more of calcium carbonate, if the mixture is not stirred sufficiently, the lime components may adhere to the kettle (decomposition vessel), reducing the efficiency of pyrolysis and making the treatment of the residue complicated. In the treatment of waste plastics, the carbonized plastic may adhere to the kettle, causing similar problems. A continuous pyrolysis furnace as described in Patent Document 4 is also known.

### PRIOR ART LITERATURE

### Patent Literature

Patent Literature 1: JP 2005-306974 A
Patent Literature 2: JP 2006-321851 A
Patent Literature 3: JP 2021-178939 A
Patent Literature 4: JP 9-279161 A

### SUMMARY OF THE INVENTION

### Problem to be Solved by the Invention

In view of the above-mentioned conventional situation, an object of the present invention is to provide an oil-liquefaction apparatus capable of performing chemical recycling without reducing the efficiency of thermal decomposition, and an oil-liquefaction method using the same.

### Means for Solving the Problems

In order to achieve the above object, the oil-liquefaction apparatus according to the present invention is characterized by comprising a pyrolysis furnace for pyrolyzing a synthetic resin-containing material that is input, and a condenser for condensing a pyrolysis gas generated in the pyrolysis furnace, said pyrolysis furnace including at least a pyrolysis cauldron for holding the material to be treated, a heating furnace for heating the pyrolysis cauldron from the outside, a stirring device for stirring the material within the pyrolysis cauldron, and a discharge section for discharging pyrolysis gas generated in the pyrolysis cauldron to the condenser, said pyrolysis cauldron has a bottom portion having a bottom surface formed by a body of revolution of a line segment whose center is convex downward, a substantially cylindrical middle portion having an inner annular surface continuous with the bottom surface, and a lid portion covering an upper portion of the middle portion, said heating furnace heats the bottom and at least a lower portion of the middle part of the pyrolysis cauldron, and said stirring device has a shaft portion that rotates at the center of the pyrolysis cauldron and a blade portion attached to the shaft portion, and the blade portion being brought into sliding contact with the bottom surface and the annular surface by the rotation of the shaft portion.

According to the above configuration, the pyrolysis cauldron has a bottom portion having a bottom surface formed by a rotating body of a line segment with a convex center facing downward, a substantially cylindrical middle portion having an inner annular surface continuing to the bottom surface, and a lid portion covering the upper part of the middle portion. Therefore, the material heat-treated in the pyrolysis kettle is liquefied and is filled sequentially from the central convex portion of the bottom portion. And, since the heating furnace heats the bottom portion and at least the lower portion of the middle portion of the pyrolysis kettle, it is possible to heat the liquefied portion of the material intensively, and efficiently conduct heat inside the pyrolysis kettle to promote decomposition.

As mentioned above, the carbonized residue of the material and solids such as calcium carbonate are likely to adhere to the inner wall (inner surface) of the pyrolysis cauldron when they come into contact with the heated portion. However, as described above, the liquefied material is filled in succession from the convex part in the center of the bottom, and the rotation of the shaft part causes the blade part to slide against the bottom surface and the annular surface, so that the stuck material is chipped off together with the liquefied components, and no part of the material sticks (adheres) to the bottom of the pyrolysis pot, or even if a small amount of the material does stick, the blade part tears off the stuck material while it is still small. In this way, the formation of stuck material on the inner surface of the pyrolysis pot is suppressed, and the decrease in pyrolysis efficiency is suppressed.

In the above-mentioned configuration, it is preferable that the tank located below the condenser is heated from the outside with exhaust gas from the heating furnace, so that the exhaust gas from the heating furnace can be effectively utilized and the operating efficiency of the entire oil production system can be improved.

The heating furnace may have a combustion device and an off-gas piping for inducing the off-gas passing through the condenser to the combustion device as a combustion fuel. The exhaust gas from the heating furnace can be effectively utilized, and the operating efficiency of the entire oilification device can be further improved. In the same configuration, an air supplying device for supplying combustion air to the combustion device may be provided, and the air piping of the air supplying device may be connected to the combustion device through a venturi, and the off-gas piping may be connected to the venturi to supply the off-gas to the combustion device by suction. The off-gas can be accumulated using a condenser, and the supply amount of the off-gas can be adjusted by the air supply amount of the air supplying device, so that the entire device is utilized without waste. Furthermore, the off-gas piping may have a gradient that increases from the condenser side to the combustion device side, and a trap chamber that reduces the flow rate of the off-gas may be provided near the combustion device. Since the liquefied components are removed by this gradient and the trap chamber, the flame in the combustion device is extremely stable, and pyrolysis can be optimally maintained.

On the other hand, the drive unit of the stirring device is provided on the lid of the pyrolysis cauldron, and the lid can be opened and closed relative to the intermediate part, and the shaft is divided into a lower shaft to which the blade is attached and an upper shaft that can be inserted and fitted into the lower shaft and is connected to the drive unit, and the intermediate part has a shaft holder that rotatably holds the lower shaft. The pyrolysis cauldron has a bottom having a bottom surface formed by a rotating body of a line segment whose center is convex downward, and a substantially cylindrical intermediate part whose inner annular surface is continuous with the bottom surface, and the shaft holder rotatably holds the lower shaft, so that the blades rotate stably without eccentricity and the material to be treated can be prevented from sticking to the inside of the kettle. Moreover, the lid can be opened and closed relative to the intermediate part, and maintenance of the pyrolysis kettle can be easily performed by opening the lid.

The outlet to the discharge section may be provided in the lid and positioned above the boiling liquid level at which the material to be treated boils when heated. Since the boiled material does not enter the outlet and only the pyrolysis gas is sent to the condenser, the purity of the oil produced can be maintained at a high level.

In the above configuration, a water trap may be interposed in the middle of the discharge section, and the water trap may have an inlet pipe for introducing the pyrolysis gas, an outlet pipe for leading the pyrolysis gas that has passed through the water trap to the condenser, and a water contact section for bringing water into contact with the pyrolysis gas. In a first aspect of this water trap, the inlet pipe may be provided with a jet supply section for supplying the pyrolysis gas to the contact section and a jet of water to the water contact section, and the outlet pipe may lead the pyrolysis gas that has passed through the water contact section to the outside. Since the pyrolysis gas is brought into contact with the jet of water, there is no clogging of nozzles or the like, and stable operation is possible. More specifically, the water contact section may have a gas supply tool that includes a bottom for receiving water, an open section for supplying the water from the jet supply section toward the bottom in a jet, and a side wall section for covering the side surface other than the open section so that the pyrolysis gas does not pass through, and the water supplied by the jet toward the outlet pipe may flow down from at least the open section side of the bottom. In a second aspect of the water trap, the water trap has a water storage section, the inlet pipe supplies the pyrolysis gas to a nozzle located in the water stored in the storage section and ejects the gas from the nozzle to form the water contact section, and the pyrolysis gas that has passed through the water contact section is ejected to the outside from the outlet pipe located above the water surface in the storage section. In addition to the first and second aspects, the inlet pipe may be heated from the outside by exhaust gas from the heating furnace. In particular, since the pyrolysis gas of PET turns from a gas to a solid at less than 300 degrees, precipitation of solids can be suppressed. Furthermore, between the inlet pipe and the outlet pipe, there is provided a bypass path that can be switched to bypass the water trap, and this bypass path may be horizontal or have a gradient that descends toward the pyrolysis vessel side. If PET or PVC is not being treated, a water trap is not necessary, and if there is a gradient that descends toward the distillation column when bypassing, moisture and foreign matter are likely to be mixed into the distillation column, and this can prevent such mixing.

It should be noted that the material to be treated includes a composite material containing 50% or more of an inorganic substance such as calcium carbonate, such as LIMEX (registered trademark). Even if the material is made of such a material, it can be sufficiently stirred, so that the material to be treated can be prevented from adhering to the inner surface of the pyrolysis furnace, and pyrolysis can be efficiently performed. In addition, the material to be treated may include waste plastics or waste tires.

In each of the above aspects, the condenser may include a first condenser for condensing the pyrolysis gas generated in the pyrolysis furnace and a second condenser for condensing the gas generated in the first condenser, and the length of the condensation section of the second condenser may be longer than the length of the condensation section of the first condenser. With this configuration, it is possible to more efficiently condense and liquefy the gas components, and to recover more of the liquefied components.

On the other hand, the oil-liquefaction method for pyrolyzing synthetic resin-containing materials using the oil-liquefaction apparatus is characterized in that the pyrolysis is carried out by heating the pyrolysis cauldron filled with nitrogen gas. Heated synthetic resin is in a state where it is likely to combine with oxygen to produce carbon dioxide, but by filling the pyrolysis vessel with nitrogen gas, the production of carbon dioxide can be prevented.

Another feature of the oil-liquefaction method for pyrolyzing synthetic resin-containing materials using the oil-liquefaction apparatus is that the solid materials are heated in the pyrolysis cauldron together with oil. Solid materials tend to have poor heat transfer with the inner wall of the pyrolysis cauldron, which can lead to a situation where pyrolysis is not promoted. If the solid materials are heated in the pyrolysis cauldron together with oil, the heat transfer is promoted by the oil, and pyrolysis proceeds efficiently.

In addition, the oil-liquefaction method for pyrolyzing a synthetic resin-containing material using the oil-liquefaction device involves stirring the treated material by sliding the blades on the inner surface of the pyrolysis tank below a sliding line above the upper adhesion line where the material adheres. The material is prone to sticking to the heating section of the pyrolysis tank, and if this is left unattended, heat transfer will be hindered, the efficiency of pyrolysis will decrease, and damage to the pyrolysis tank will progress. According to this method, the sliding contact of the blades prevents the material from sticking, and pyrolysis will be promoted.

Furthermore, in the oil-liquefaction method for pyrolyzing a synthetic resin-containing material using the oil-liquefaction device, the outlet to the discharge section is provided in the lid, and the input amount of the material to be treated is restricted so that the outlet is located above the boiling liquid level formed when the material is liquefied by heating and stirring in the pyrolysis tank. According to this method, the boiled material is not mixed into the outlet, and only the pyrolysis gas is sent to the condenser, so that the purity of the oil can be maintained high.

In addition, in any of the above-mentioned oil-liquefaction apparatuses, the rising portion of the blade portion that slides against the annular surface may be formed in a spiral direction about the axis of the annular surface. For example, as shown in FIGS. 17(a) and 17(b), when only a rising portion 26b of a blade part 26 is spiral about the central axis CA, which is the axis of the annular surface, when the blade part 26 rotates clockwise in a plan view, the material to be treated is forcibly sent from top to bottom in the portion close to the ring-shaped surface 21e of the pyrolysis cauldron 21. As a result, the material to be treated is pressure-fed toward the bottom side, increasing its density, and improving the heat transfer efficiency of pyrolysis.

### Effects of the Invention

According to the above-mentioned features of the oil-liquefaction apparatus and the oil-liquefaction method using the same according to the present invention, it is possible to carry out chemical recycling without reducing the efficiency of thermal decomposition.

Other objects, configurations and effects of the present invention will become apparent from the following detailed description of the preferred embodiments of the present invention.

### BRIEF DESCRIPTION OF DRAWINGS

FIG. 1 is a schematic view showing an oil-liquefaction apparatus according to the present invention.

FIG. 2 is a schematic view illustrating the flow of gas in the oil-liquefaction apparatus.

FIG. 3 is a view showing a pyrolysis cauldron and a blade part.

FIG. 4 is a front view showing the blade part.

FIG. 5 is a side view showing the blade part.

FIG. 6 is a plan view showing the blade part.

FIG. 7 is a bottom view showing the blade part.

FIG. 8 is a vertical cross-sectional view showing the pyrolysis cauldron, in which (a) shows a case wherein the line segment is curved, and (b) shows the line segment is a straight line.

FIG. 9 shows the relationship between the vertical section and the plan view of the pyrolysis cauldron, in which (a) is a vertical cross-sectional view of a pyrolysis cauldron with a downward convex center, (b) is a plan view of the case of (a), (c) is a vertical cross-sectional view of a pyrolysis cauldron with a downward convex periphery, which is a comparative example, and (d) is a plan view of the case of (c).

FIG. 10 shows the relationship between the three-way expedient and switching, in which (a) shows the diagrammatic representation of a three-way valve, (b) shows the case where A and B are communicated, and (c) shows the case where A and C are communicated.

FIG. 11(a) shows a configuration diagram of the combustion device and its vicinity, and (b) is a diagram showing the configuration of the off-gas path of the second condenser.

FIG. 12 shows a first aspect of a water trap, in which (a) is a front view, and (b) is a cross-sectional view taken along line A-A in (a).

FIG. 13 shows a second aspect of a water trap, in which (a) is a front view, and (b) is a cross-sectional view taken along line B-B in (a).

FIG. 14 is a diagram showing off-gas diversion paths to bypass the water trap.

FIG. 15 is a diagram showing a switching path for exhaust heat gas for bypassing the preheating of pyrolysis gas when a water trap is provided.

FIG. 16 is a view showing a modified example of the connection part of the discharge part.

FIG. 17 shows the relationship between a vertical cross-sectional view and a plan view of the pyrolysis cauldron and the blade part, in which (a) shows a vertical cross-sectional view of a pyrolysis vessel in which only the rising portion is spiral, (b) shows a plan view of the case of (a), (c) shows a vertical cross-section of a pyrolysis cauldron having both a spiral rising portion and a spiral lower edge, and (d) shows a plan view of (c).

### DETAILED DESCRIPTION OF THE PREFERRED EMBODIMENTS

Next, the present invention will be described in more detail with reference to the accompanying drawings as appropriate.

### (Overall Configuration of Oil-Liquefaction Apparatus 1)

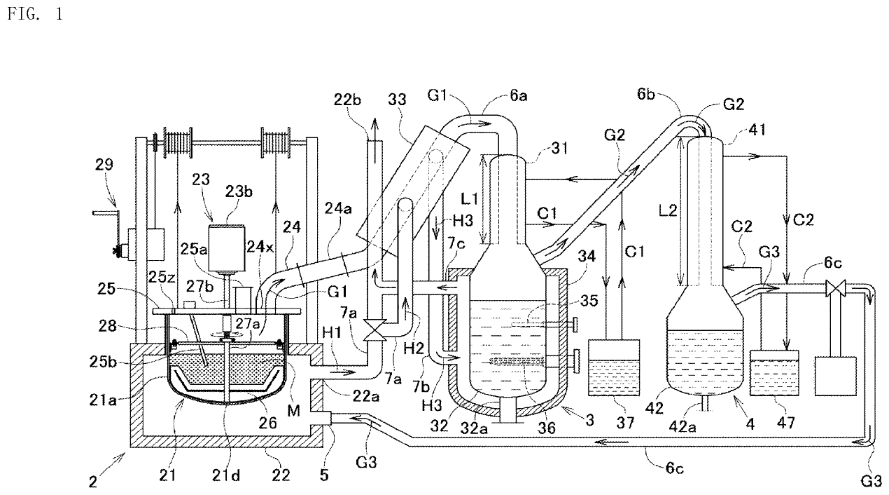

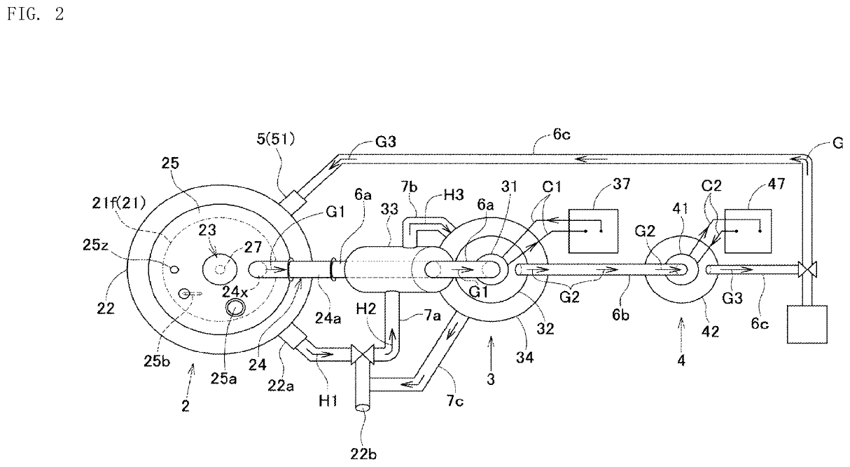

As shown in FIGS. 1 and 2, an oil-liquefaction apparatus 1 according to the present invention generally comprises a pyrolysis furnace 2 for pyrolyzing a synthetic resin-containing material M to be treated, a first condenser 3 for condensing a pyrolysis gas G1 generated in the pyrolysis furnace 2, and a second condenser 4 for condensing a gas G2 generated in the first condenser 3. The heating furnace 22 of the pyrolysis furnace 2 has a combustion device (deodorization device) 5 for high-temperature deodorization of the off-gas G3 generated in the second condenser 4. These are connected by gas pipes 6a to 6c and exhaust pipes 7a to 7c.

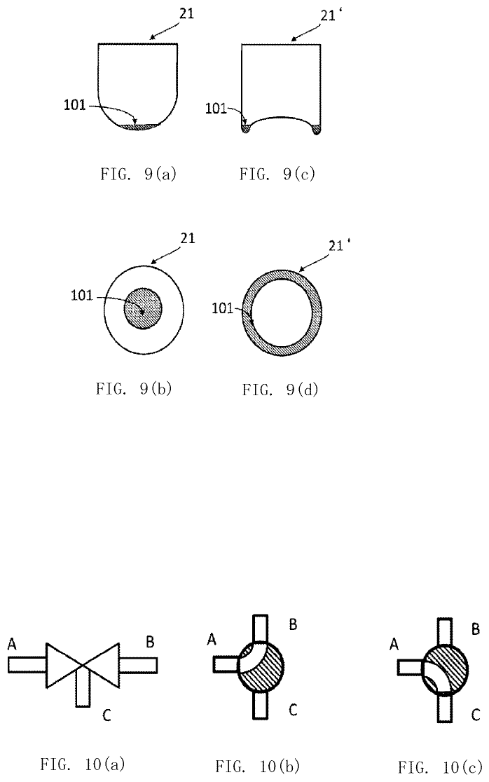

The three-way valve shown in FIGS. 1 and 2 is a valve having inlets and outlets for fluid in three directions (designated A, B, and C in the figure) as shown in FIG. 10(a). In this valve, the route from inlet A to outlet B (FIG. 10(b)) can be switched to route C from inlet A to outlet C (FIG. 10(c)) by a handle or the like (not shown).

### (Material M)

Here, the material M to be treated (thermally decomposed) in the oil-liquefaction apparatus 1 and the pyrolysis furnace 2 of the present invention is, for example, a new material containing 50% or more of inorganic substances such as calcium carbonate, such as LIMEX (registered trademark), or waste containing the same. This material is a difficult-to-recycle material that is difficult to recycle in existing recycling schemes. In addition, since it contains 50% or more of calcium carbonate, in the case of an indirect heating method of a kettle as in the present invention, if the stirring is not sufficient, the lime component will adhere to the inner surface of the kettle to form an inner kettle, which reduces the efficiency of pyrolysis and makes the treatment of the residue complicated. In the pyrolysis furnace 2 of this embodiment, the material M to be treated (material to be put into the cauldron) is sufficiently stirred during heat treatment and directly comes into contact with the hot inner surface of the kettle for thermal conduction, so that even such a material can be highly efficiently chemically recycled.

The material to be processed M is not limited to the above-mentioned materials, and highly efficient chemical recycling is possible for plastic materials such as PE (polyethylene), PP (polypropylene), PS (polystyrene), PET (polyethylene terephthalate), PVC (polyvinyl chloride), and plastic waste (waste plastics) containing these plastic materials, as well as tire waste.

### (Overall Configuration of Pyrolysis Furnace 2)

The pyrolysis furnace 2 includes at least a pyrolysis cauldron 21 that holds the input material M to be treated, a heating furnace 22 that heats the pyrolysis cauldron 21 from the outside, a stirring device 23 that stirs the material M in the pyrolysis cauldron 21, and a discharge section 24 that discharges the pyrolysis gas G1 generated in the pyrolysis cauldron 21 to the first condenser 3.

### (Pyrolysis Cauldron 21, Discharge Section 24)

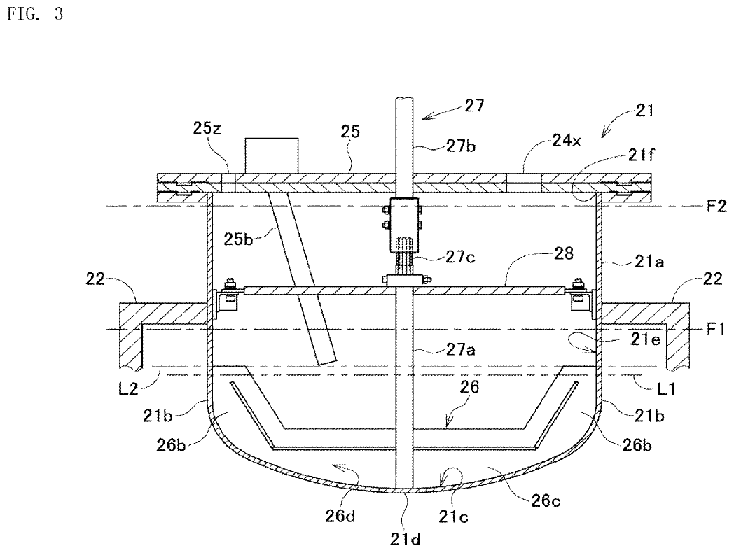

As shown in FIGS. 1 and 3, the pyrolysis cauldron 21 has a cylindrical middle part 21a with an open top, a bottom part 21d with a bottom curved surface 21c that is continuous from a lower end 21b of the middle part 21a and has a convex bottom curved surface 21c that is convex downward, and a lid part 25 that covers the upper part of the middle part 21a. The shape of the pyrolysis cauldron 21 and the stirring device 23 described later suppress the generation of residues. In addition, the bottom part 21d does not have an outlet for discharging residues, etc. If an outlet is provided in the bottom part 21d, there will be a part inside (inner surface) of the pyrolysis cauldron 21 where the temperature of the furnace is not transmitted, and the heat conduction will decrease, and the efficiency of pyrolysis will also decrease. In this way, the bottom part 21d and the shape of the bottom part 21d improve the efficiency of heat conduction from the bottom part 21d to the processing material M. Moreover, it is possible to take out (discharge) residues, etc. from the upper part of the middle part 21a. This avoids a decrease in the efficiency of heat conduction (pyrolysis) and also improves workability. In this embodiment, an opening at the top of the intermediate portion 21a serves as an outlet 21f for removing the treated material (residue, etc.) after pyrolysis.

As shown in FIG. 1, the lid part 25 can be opened and closed with respect to the outlet 21f of the middle part 21a via a lifting mechanism 29, and the maintenance of the pyrolysis cauldron 21 can be easily performed by opening the lid part 25p. The lid part 25 is provided with an inlet 25a for introducing the material M to be treated and a discharge outlet 24x communicating with the discharge section 24 for discharging (supplying) the pyrolysis gas G1 generated inside the kettle toward the first condenser 3 (outside). In this embodiment, a detachable connecting portion 24a is provided between the discharge section 24 and the first gas pipe 6a connecting to a first condenser portion 31 of the first condenser 3. The lid part 25 is provided with the stirring device 23 to be described later, a thermocouple 25b for measuring the temperature inside the cauldron, and an inlet 25z for introducing an inert gas such as nitrogen into the cauldron. It is also possible to open the lid part 25 and introduce the material M to be treated through the opening or outlet 21f.

### (Heating Furnace 22)

As shown in FIGS. 1 and 2, the heating furnace 22 is provided so as to surround the pyrolysis cauldron 21, and the pyrolysis cauldron 21 is installed replaceably on the upper part of the heating furnace 22. This allows the pyrolysis cauldron 21 to be removed from the heating furnace 22 to treat the residue, making it easy to recover the residue and improving workability. The heating furnace 22 also has a combustion device 5, which will be described later, and heats the bottom part 21d of the pyrolysis cauldron 21 and at least the lower part 21b of the intermediate part 21a. An exhaust port 22a is provided on the upper side of the heating furnace 22 as an exhaust heat supply part that exhausts (supplies) the exhaust gas in the furnace to a heat retaining member 33 and an exterior member 34, which will be described later. The first exhaust pipe 7a is connected to this exhaust port 22a, and the exhaust port 22a is connected to an exhaust tower 22b via a valve.

### (Stirring Device 23)

As shown in FIGS. 1 and 3, the stirring device 23 has a drive unit 23b provided on the lid part 25 of the pyrolysis cauldron 21, and generally includes a shaft 27 that rotates at the center of the pyrolysis cauldron 21, a blade part 26 attached to the lower part of the shaft 27, and a shaft holder 28. In this embodiment, the shaft 27 is divided into a lower shaft part 27a to which the blade unit 26 is attached, and an upper shaft part 27b that extends from the drive unit 23b of the stirring device 23, can be inserted and fitted into the lower shaft part 27a, and is connected to the drive unit 23b. Furthermore, the shaft holder 28 rotatably holds the lower shaft part 27a on the middle part 21a. This allows the blade unit 26 to rotate stably without eccentricity, and prevents the material M from sticking to the inside of the cauldron.

### (Blade Part 26)

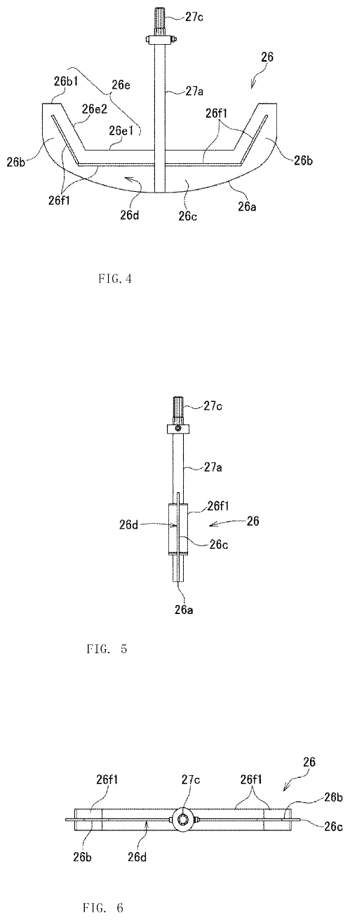

As shown in FIGS. 3 to 7, the blade part 26 has a lower edge portion 26a curved along the bottom curved surface 21c of the bottom part 21d of the pyrolysis furnace 21, and a pair of rising portions 26b rising from both sides of the lower edge portion 26a along an annular surface 21e of the middle part 21a of the pyrolysis cauldron 21. The lower ends of the lower edge portion 26a and the rising portions 26b of the blade part 26 are closely opposed to the bottom curved surface 21c of the bottom part 21d and the annular surface 21e of the lower end 21b of the middle part 21a. There is only a small gap between them (there is practically no gap) so that they do not come into contact with each other, and the blade part 26 is made to slide against the bottom curved surface 21e and the annular inner surface 21e by rotating it at the bottom of the pyrolysis cauldron 21. This allows the material M to be peeled off or removed while still small so that it does not stick to the bottom 21d (bottom curved surface 21c) and annular surface 21e of the pyrolysis cauldron 21 during pyrolysis, thereby suppressing a decrease in the efficiency of pyrolysis.

In this embodiment, the blade part 26 is a plate-like member 26c that is thinner than the diameter of the shaft 27 including the lower shaft part 27a described later. The plate-like member 26c has a flat surface 26d that is parallel to the axial direction of the shaft 27 and perpendicular to the bottom curved surface 21c and the annular surface 21e of the bottom part 21d. This makes it easier for the blade part 26 to remove the adherent matter (processed matter M) from the bottom part 21d and the annolar surface 21e of the pyrolysis cauldron 21, even if the material M adheres slightly, and further suppresses adhesion of the material M to be processed.

Furthermore, in this embodiment, an upper edge 26e of the blade part 26 has a straight portion 26e1 perpendicular to a shaft portion 23a, and an inclined portion 26e2 connecting an upper end 26b1 of the rising portion 26b and the straight portion 26e1. As shown in FIG. 3, the thermocouple 25b is disposed near the center side (lower shaft part 27a) of the inside of the pyrolysis cauldron 21. With this shape of the blade part 26, it is possible to avoid contact with the thermocouple 25b and to accurately measure the temperature. Moreover, since the material M to be treated near the side surface 21e can be guided (stirred) to the center side of the furnace (lower shaft part 27a), the efficiency of pyrolysis is not reduced.

In this embodiment, the blade part 26 has a protruding portion 26f that stands perpendicular to the flat surface 26d of the plate-like member 26c. This protruding portion 26f is perpendicular to the shaft 27 including the lower shaft portion 27a, and stirs the material M to be treated. The blade part 26 also has the lower shaft part 27a that can be connected to the upper shaft part 27b, and the shaft holder 28 that rotatably holds the lower shaft part 27a in the middle part 21a of the pyrolysis cauldron 21. The shaft holder 28 is, for example, composed of a frame that extends in all directions from the center of the furnace, and the end of the frame is fixed to the annular surface 21e of the pyrolysis cauldron 21. In this embodiment, a connecting part 27c that connects to the upper shaft part 27b is formed at the tip of the lower shaft part 27a, and the blade part 26 is provided at the lower portion. In this way, by making the blade part 26 detachable from the stirring device 23 and retainable inside the pyrolysis cauldron 21, the pyrolysis cauldron 21 can be used interchangeably. For example, by connecting the detached pyrolysis cauldron 21 to another motor, residue disposal and maintenance can be facilitated.

Here, the Oil-liquefaction method (processing) of pyrolyzing the material M to be processed using the above-mentioned Oil-liquefaction apparatus 1 (pyrolysis furnace 2) will be described in more detail with reference to FIG. 3.

First, the material M to be treated is filled (put) into the kettle up to the material filling line F1. As heating proceeds, the material M to be treated liquefies and boils (expands), and the liquid level reaches the boiling liquid level F2, which is the material expansion line. Ane outlet 24x of the discharge section 24 is provided in the lid part 25 above the boiling liquid level F2. Therefore, the amount of material M to be treated is adjusted to be below the material filling line F1 so that the material M to be treated does not reach the boiling liquid level F2 when liquefied. In addition, by placing the material filling line F1 below the shaft holder 28, the effect on the stirring of the material M to be treated can be suppressed.

Furthermore, when the material M to be treated is filled (put in), oil is put in together with the material M to be treated. Since the material M to be treated is a solid, the heat transfer state with the inner surface (inner wall) of the pyrolysis cauldron 21 is improved by putting in oil, and pyrolysis can be efficiently promoted. The oil to be put in is, for example, waste oil recovered in the circulation process of the first and second gas pipes 6c1, 6c2 or the off-gas pipe 6c. In addition, it may be a heavy oil equivalent recovered in the first and second condensers 3, 4, or light oil or kerosene. However, oil with a high moisture content is not preferable because it requires draining.

After closing the lid part 25, nitrogen is introduced through the inlet 25z of the pyrolysis cauldron 21 to create an oxygen-free state inside the pyrolysis cauldron 21 and the discharge section 24. If oxygen is present inside during pyrolysis, it will combine with carbon in the heated material M to generate carbon dioxide, so the generation of carbon dioxide is suppressed by creating an oxygen-free state.

When heating by the heating furnace 22 begins, the outer surface of the pyrolysis cauldron 21 is heated, the material to be treated M begins to be molted from the inner surface of the cauldron, and liquid is produced on the inner surface of the cauldron at the bottom part 21d and middle part 21a. A viscous liquid (semi-solid) is produced inside the liquid, and pyrolysis gas G1 is generated in some parts. When the amount of semi-solid increases, the rotation of the shaft 27 starts and stirring by the blade part 26 starts.

As the heating continues, the liquid level of the liquefied material M reaches a boiling liquid level F2, which becomes the material expansion line. Since the discharge port 24X of the discharge section 24 is provided in the lid portion 25 which is located above the boiling liquid level F2, the liquefied processed material M does not overflow into the discharge port 24X and flow into the first condenser 3 side, and only the pyrolysis gas can be supplied (discharged) to the first condenser 3 side, thereby maintaining a high purity of the oil.

The heating (flame) of the heating furnace 22 extends to the entire inside of the heating furnace 22, but since the middle part 21a near the opening of the heating furnace 22 is close to the outside air, the inner wall of the furnace in that part is not easily heated. On the other hand, near the lower end 21b that contacts the bottom part 21d below the line L1, if stirring is insufficient, the material M to be treated is likely to stick (burn) to the inner wall of the furnace. This line L1 is the upper limit line for sticking. As shown in FIG. 3, the sliding line L2 of the blade part 26 that slides against the bottom curved surface 21c of the bottom part 21d and the annular surface 21e of the middle part 21a is located above the upper limit line L1 for sticking, so that the material M to be treated does not stick to the inner wall of the furnace. Even if a small amount of material sticks, the blade part 26 will tear off the stuck material while it is still small, and pyrolysis will be carried out efficiently.

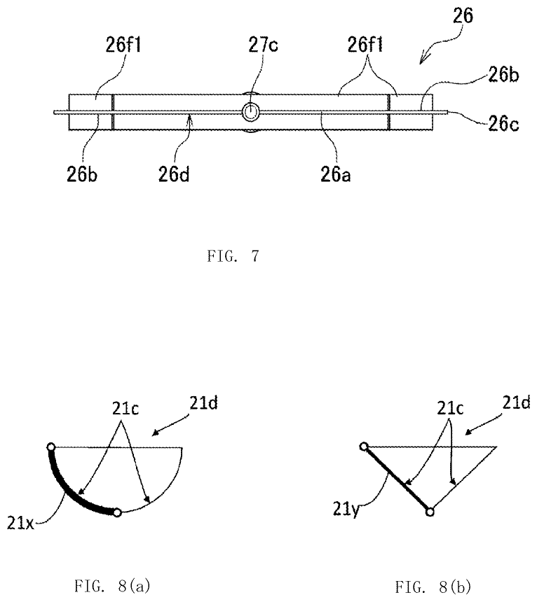

Further, the shape of the bottom 21d of the pyrolysis cauldron 22 will be described in detail with reference to FIGS. 8 and 9.

In this embodiment, as shown in FIG. 8(a), a line segment 21x is curved (a convex arc shape on the downward side), and the bottom part 21d having the bottom curved surface 21c formed by a rotating body of this line segment 21x has a hemispherical shape or a dome shape similar thereto with the center being convex toward the downward (vertically downward) direction, and the bottom surface 21c is a curved surface. Note that the line segment is not limited to a curved line, and may be a straight line segment 21y as shown in the same FIG. 8(b). In this case, the bottom part 21d having the bottom surface 21c formed by the rotating body of the straight line segment 21y has a conical shape with the center being convex toward the downward (vertical downward) direction.

In this way, where the bottom part 21d of the pyrolysis cauldron 21 has the bottom surface 21c formed by a rotating body of the line segments 21x and 21y with the center convex toward the bottom, as shown in FIGS. 9(a) and 9(b), the liquefied material 101 is filled sequentially from the central convex part of the bottom part 21d. And, this central convex part of the bottom part 21d is the part that is most likely to be heated. Therefore, gasification of the liquefied material 101 is promoted and the material M to be processed at the bottom part 21d is prevented from burning. On the other hand, the comparative example shown in FIGS. 9(c) and 9(d) has a bottom with a peripheral part that is convex toward the bottom and a central part that is concave. In the case of this pyrolysis cauldron 21′, the liquefied material 101 to be processed is filled at the peripheral part. However, since the concave part (convex part toward the upward direction) facing downward at the center of the bottom is the part that is most likely to be heated, the material M to be processed is likely to burn at this central part.

### (First Condenser 3)

As shown in FIGS. 1 and 2, the first condenser 3 generally includes the first condensation section 31 for condensing the pyrolysis gas G1, and a first storage tank 32 for storing the liquefied (oiled) hydrocarbon oil condensed in the first condensation section 31. The first gas pipe 6a connected to the upper part of the first condensation section 31 is provided with a heat retaining member 33 for covering the periphery. The first storage tank 32 is also covered with the exterior member 34. The first condensation section 31 is supplied (circulated) with cooling water C1 from a cooling water tank 37. The bottom of the first storage tank 32 is provided with an outlet 32a for taking out (discharging) the liquefied (oiled) hydrocarbon oil.

Here, the first exhaust pipe 7a connected to the exhaust port 22a of the heating furnace 22 is connected to the lower part of the heat-retaining member 33 via a switching valve (not shown). On the other hand, the second exhaust pipe 7b that supplies the exhaust gas H2 that has flowed inside the heat-retaining member 33 to the exterior member 34 is connected to the upper part of the beat-retaining member 33. The second exhaust pipe 7b is connected to the lower part of the exterior member 34, and the third exhaust pipe 7c that exhausts the exhaust gas H3 that has flowed inside the exterior member 34 to the outside is connected to the upper part. The third exhaust pipe 7c is connected to the exhaust tower 22b. In this way, the exhaust heat H1 from the heating furnace 22 is supplied to the inside of the heat-retaining member 33 and the exterior member 34 (exhaust gas H2, H3), so that the first storage tank 32 and the first gas pipe 6a are heated from the outside by the exhaust gas of the heating furnace 21. Therefore, the exhaust gas can be effectively utilized, improving the operating efficiency of the entire oilification apparatus and contributing to energy saving.

Further, a heater 35 for heating the inside of the first storage tank 32 is attached to the exterior member 34. For example, the first storage tank 32 is heated to a temperature range of 150° C. by this heater 35, and light oil having a flash point of 20° C. or less is separated so as to be recoverable in the second condenser 4. The gas G2 generated in the first condenser 3 is supplied to the second condenser 4 via the second gas pipe 6b at the upper part of the first storage tank 32.

### (Second Condenser 4)

As shown in FIGS. 1 and 2, the second condenser 4 generally includes a second condensing section 41 for condensing the gas G2 and a second storage tank 42 for storing the liquefied (oiled) light hydrocarbon oil condensed in the second condensing section 41. The second condensing section 41 is supplied (circulated) with cooling water C2 from a cooling water tank 47. The bottom of the second storage tank 42 is provided with an outlet 42a for taking out (discharging) the liquefied (oiled) light hydrocarbon oil. A cooling water tank 37 of the first condenser 3 and the cooling water tank 47 of the second condenser 4 are separate systems, and each is controlled independently. The cooling water C2 in the cooling water tank 47 is cooled by a radiator (not shown) and reused. By cooling the downstream cooling water, excess oil and the like are prevented from being contained in the off-gas G3.

Here, the length L2 of the second condenser section 41 is longer than the length L1 of the first condenser section 31, for example, at least twice as long. This improves the oil conversion rate in the second condenser 4 and prevents the outflow (circulation) of oil mist into the off-gas G3. As described later, in the present invention, the off-gas G3 is reused in the heating furnace 22, so impurities in the off-gas G3 are reduced by lengthening the length L2 of the second condenser section 41.

### (Combustion Device 5)

In this embodiment, the off-gas G3 that passes through (is generated) without being condensed in the second condenser 4 is guided (supplied) as combustion fuel from the top of the second storage tank 42 through the third gas pipe (off-gas pipe) 6c to the combustion device (deodorization device) 5. This allows the exhaust gas from the heating furnace 21 to be used more effectively, improving the operating efficiency of the entire oilification system.

As shown in FIGS. 1 and 2, the combustion device 5 has a burner unit 51 that burns the off-gas G3 together with oxygen supplied from the outside. As described above, the first exhaust pipe 7a is connected to the heating furnace 22, and the exhaust gas from the heating furnace 22 is supplied to the heat-retaining member 33 and the exterior member 34 via the second exhaust pipe 7b and the third exhaust pipe 7c. In this way, the off-gas G3 is not released into the atmosphere but is subjected to high-temperature treatment (combustion) to be deodorized and reused, resulting in good energy efficiency.

Here, the combustion device 5 and the off-gas pipe 6c will be described in more detail with reference to FIG. 11.

Furthermore, a combustion pipe 6c5 of the off-gas piping 6c is connected to a venturi 53. When an air supply unit 52 supplies the combustion air to the venturi 53, the inside of the venturi 53 becomes negative pressure, and the off-gas G3 is sucked from the combustion pipe 6c5. In this way, the supply amount of the off-gas G3 can be adjusted by the air supply amount of the air supply unit 52, so that the off-gas G3 can be effectively utilized. Then, the gas in which the combustion air and the off-gas G3 are mixed is supplied to the burner unit 51 and ignited by a plug 54.

As shown in FIGS. 11(a) and 11(b), the off-gas piping 6c generally includes an outlet pipe 6c1 provided at the upper part of the second storage tank 42, the a discharge pipe 6c2 for discharging oil collected in the outlet pipe 6e1 to the outside, and a gradient pipe 6c3 that communicates with the outlet pipe 6c1, is provided near the combustion device 5, and is connected to a trap chamber 6x that reduces the flow velocity of the off-gas G3.

The gradient pipe 6c3 has an ascending gradient from the second storage tank 42 (condenser) side toward the combustion device 5 side, and the part of the off-gas pipe 6c where the discharge pipe 6c2 is provided is at the lowest position. The off-gas G3 is cooled in the process of flowing through the off-gas pipe 6c, and the oil contained therein is liquefied. By providing the above-mentioned gradient, the oil generated in the pipe can be guided and collected to the discharge pipe 6c2 provided with a lower valve 6y. By collecting the excess oil, impurities as fuel can be removed, and the dirt and clogging of the pipes can be prevented.

A trap chamber 6x has an internal space that expands in a direction perpendicular or intersecting the inflow direction from the gradient pipe 6c3, and a branch pipe 6c4 is provided along the inflow direction of the gradient tube 6c3. The off-gas G3 discharged from the gradient tube 6c3 into the internal space collides with the wall of the internal space, and the oil contained therein adheres to the wall upon collision. This allows further oil to be removed from the off-gas G3, and the flame of the combustion device 5 can be stably maintained, and thermal decomposition is also stabilized.

The branch pipe 6c4 is provided with a first valve 6d1 for adjusting the gas supply to the combustion pipe 6c5 connected to the venturi 53, and a second valve 6d2 for adjusting the gas supply to a power generation pipe 6c6 connected to a power generation unit 40. As described above, the off-gas G3 is sucked in by the venturi 53, so that the combustion in the heating furnace 22 can be controlled by adjusting the gas supply with the first valve 6d1. The power generation unit 40 includes, for example, a hydrogenation device 41 and a power generation device 43 such as a fuel cell, and the amount of power generation can be controlled by adjusting the gas supply with a second valve 6d2.

### Other Embodiments

Next, we will discuss the possibility of other embodiments of the present invention. Note that the same reference numerals are used to designate the same components as in the above-described embodiment.

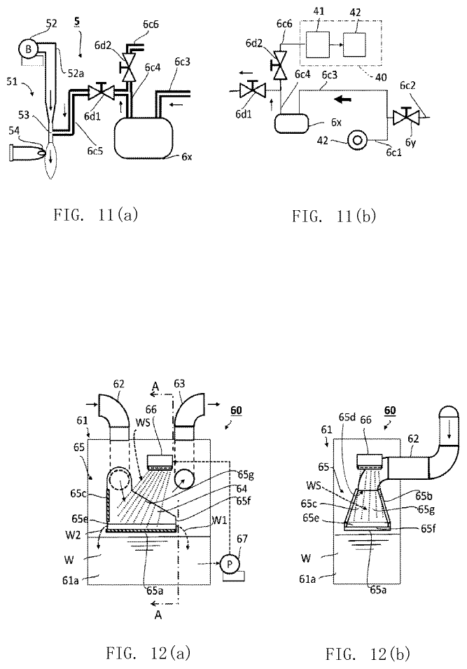

In the above embodiment, the pyrolysis gas G1 generated in the pyrolysis cauldron 21 is supplied to the first gas pipe 6a connected to the upper part of the first condenser portion 31 through the discharge section 24 that exhausts the gas to the outside of the furnace. However, as shown in FIG. 15, a water trap 60 as exemplified in FIG. 12 and FIG. 13 may be interposed in the middle of the exhaust part 24 (between the pyrolysis cauldron 21 and the first condenser 3).

The water trap 60 generally includes an inlet pipe 62 for introducing the pyrolysis gas G1, an outlet pipe 63 for leading the pyrolysis gas G1 that has passed through the water trap 60 to the first condenser portion 31 (condenser) described below, and a water contact section 64 for bringing the pyrolysis gas G1 into contact with water W. The water trap 60 is provided with a main body 61 having a storage section 61a for storing the water W, and the inlet pipe 62 and outlet pipe 63 are attached to the upper part of the main body 61.

The inlet pipe 62 supplies the pyrolysis gas G1 to the water contact section 64, and the outlet pipe 63 outlets the pyrolysis gas G1 that has passed through the water contact section 64 to the outside (first condenser section 31) of the main body 61 of the water trap 60. In the water trap 60 of the first embodiment shown in FIG. 12, the water trap 60 is provided with a shower as a jet supply section 66 that supplies a jet of water WS to the water contact section 64. Water W stored in a storage section 61a is pumped up by a pump 67 and supplied to the shower 66.

In the water trap 60 illustrated in FIG. 12, the water contact section 64 has a gas supply device 65 equipped with a bottom 65a for receiving water W, an upper opening 65g as an open portion for supplying water from a shower 66 toward the bottom 65a in a jet WS, and a side portion 65b and a rear portion 65c as side wall portions surrounding the upper opening 65g to prevent the pyrolysis gas G1 from passing therethrough.

An inlet 65d at the top of the gas supply tool 65 is connected to the inlet pipe 62, and a pair of side parts 65b are provided facing each other across the bottom 65a. The rear part 65c is provided from the inlet 65d toward the bottom 65a between the pair of side parts 65b, 65b. Therefore, the pyrolysis gas G1 supplied from the inlet 65d heads toward the upper opening 65g without being diffused by these side wall parts 65b, 65c. The lower end of the rear part 65c does not contact the bottom part 65a, and a rear slit 65e is formed. The pyrolysis gas G1 supplied to the upper opening 65g contacts the jet WS supplied from the shower 66. Since the pyrolysis gas G1 contacts the jet WS at the upper opening 65g (water contact section 64), there is no clogging of the inlet pipe 62, and stable operation can be achieved.

Here, where the material M contains PET (polyethylene terephthalate), it is gasified when pyrolyzed at about 300° C. and is contained in the pyrolysis gas G1. However, since PET (polyethylene terephthalate) turns from gas to solid (recrystallizes) at about 250° C., it may crystallize in the discharge section 24 or the gas pipe 6a and adhere to the inner surface of the pipe, causing the pipe to be clogged upstream of the first condenser 3. In addition, when the material M contains PVC (polyvinyl chloride), the Cl (chlorine) component of PVC (polyvinyl chloride) is contained in the pyrolysis gas G1. It is necessary to remove the Cl (chlorine) component because it affects the corrosion of equipment such as pipes.

Therefore, by bringing the water W and the pyrolysis gas G1 into contact with each other at the water contact portion 64 of the water trap 60, the pyrolysis gas G1 is cooled to 50° C. or more, so that the PET component is crystallized and can be recovered together with the water W. Since PET has a large specific gravity, it settles at the bottom of the storage portion 61a. Therefore, clogging due to crystallization of the PET component can be suppressed in the piping upstream of the first condenser 3 (downstream of the water trap 60), and the recovery efficiency of heavy oil and the like is improved. Moreover, Cl (chlorine content) of PVC (polyvinyl chloride) is easily soluble in water, so it can be dissolved in water W by the water trap 60 and recovered.

In this way, by providing the water trap 60 in the middle of the discharge section 24, these components can be removed upstream of the first condenser 3, making it suitable for use in chemical recycling of the treated material M containing PET (polyethylene terephthalate) and PVC (polyvinyl chloride). Although it is preferable to separate the PET bottles, labels, and caps and then perform heat treatment in terms of chemical recycling efficiency and the purity of the extracted oil, providing the water trap 60 may enable heat treatment without separating them.

Then, a part W1 of the water that has come into contact with the jet WS at the upper opening 65g flows down from a front edge 65f on the upper opening 65g side of the bottom 65a into the storage section 61a. In this example of FIG. 12, the rear slit 65e is formed, so the remaining water W2 that has come into contact flows down from the rear slit 65e into the storage section 61a. As described above, the water W stored in the storage section 61a is pumped up by the pump 67 and supplied again as the jet WS from the shower 66, and is used repeatedly. It is advisable to provide a measuring device for pH, chlorine concentration, etc. in the supply process (piping) to the shower 66, monitor the measurements, and manually or automatically collect and replace the water W.

In the water trap 60 of the second embodiment shown in FIG. 13, the gas supplying tool 65 is omitted, and the inlet pipe 62 supplies the pyrolysis gas G1 to a jet outlet 68 located in the water W stored in the storage section 61a, and the pyrolysis gas G1 is jetted from the jet outlet 68 to form the water contact section 64. The jet outlet 68 is, for example, a plurality of through holes drilled in the inlet pipe 62. As a result, the pyrolysis gas G1 jetted from the jet outlet 68 is cooled in the water W of the storage section 61a, the PET component is crystallized, and Cl (chlorine content) of PVC (polyvinyl chloride) is dissolved in the water W and can be recovered. Then, the pyrolysis gas G1 that has passed through the storage section 61a (water contact section 64) is discharged to the outside from an outlet 63a of the outlet pipe 63 located above the water surface of the storage section 61a.

Note that in the example of FIG. 13, a remover 69 is provided near the jet outlet 68 of the discharge pipe 63. The remover 69 is composed of an annular portion 69a and a remover 69b such as a brush, and the remover 69b is slidably moved around the periphery of the outlet 68 along the axial direction of the discharge pipe 63 via the annular portion 69a to remove the PET components adhering to the outlet 68 and prevent clogging. Similarly to the above example, the water W is pumped up by the pump 67 and supplied to the storage portion 61a for reuse.

As described above, PET (polyethylene terephthalate) recrystallizes at about 250° C. Therefore, it is desirable to heat the inlet pipe 62 so that the pyrolysis gas G1 is not cooled just before being introduced into the water trap 60. In this case, as shown in FIG. 15, as a heating means, for example, the introduction pipe 62 is heated from the outside with the exhaust gas H1 of the heating furnace 22. The introduction pipe 62 is covered with a heat-retaining member 33, and the exhaust gas H1 of the heating furnace 22 is supplied from the exhaust port (exhaust heat supply section) 22a of the heating furnace 22 to the inside of the heat-retaining member 33 through the first exhaust pipe 7a. This prevents the introduction pipe 62 from becoming 250° C. or lower, and the PET component from recrystallizing in the inlet pipe 62.

A second exhaust pipe 7b is connected to the heat retaining member 33, which exhausts the exhaust gas that has flowed through the heat retaining member 33 to the outside. The second exhaust pipe 7b is connected to the exhaust tower 22b via a third exhaust pipe 7c, and a valve 7x is provided in the middle of the second exhaust pipe 7b. When a bypass path 70 (described later) is used, the entire amount of the exhaust gas H1 from the heating furnace can be supplied to the inside of the exterior member 34 via a fourth exhaust pipe 7d by closing the valve 7x, thereby contributing to energy saving.

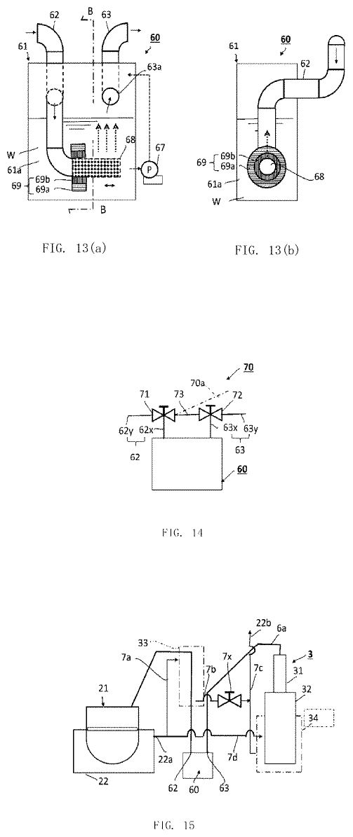

In addition, when installing the water trap 60, a switchable bypass path 70 may be provided between the inlet pipe 62 and the outlet pipe 63 so as to bypass the water trap 60. For example, as shown in FIG. 14, an inlet side three-way valve 71 is provided in the inlet pipe 62, and an outlet side three-way valve 72 is provided in the outlet pipe 63, and these three-way valves 71, 72 are connected by a horizontal pipe 73 to form a switchable bypass path 70. Note that instead of the horizontal pipe 73, a gradient pipe 70a that descends toward the pyrolysis cauldron 21 side may be provided. If the material M to be treated does not contain PET or PVC, the water trap 60 is not necessary, and by providing a gradient in the bypass path 70, it is possible to prevent moisture and foreign matter from flowing into the condenser side.

The water trap 60 of each of the above aspects can be applied not only to the batch-type pyrolysis cauldron 21 as in the above embodiment, but also to a continuous pyrolysis device. For example, in the continuous pyrolysis furnace shown in Patent Document 4, the water trap 60 can be connected to the pyrolysis gas exhaust duct 6 as a PET removal device, and an oilification device combining these can be implemented.

In each of the above embodiments, the discharge section 24 communicating with the discharge outlet 24x of the lid section 25 is provided with the connecting section 24a that can be attached and detached to the first gas pipe 6a that connects to the first condenser section 31. However, as long as the lid section 25 can be opened and closed, the configuration of the connecting section is not limited to that of the above embodiment.

For example, the discharge section 24 shown in FIG. 16 has an elbow 24e that connects the connecting section 24b located outside the moving track 25′ of the lid section 25 when the lid section 25 is opened or closed, and the discharge outlet 24x, and a hinge 24y is provided at the upper part where the elbow 24e and the connecting section 24b are connected. As a result, as shown by the dashed line in the figure, the elbow 24e can swing to the upper part of the connecting section 24b by the hinge 24y and move (evacuate) outside the moving track 25′ of the lid part 25 (symbol 24e′). In the above embodiment, it is difficult to align the straight pipe connecting section 24a due to thermal expansion of each pipe, but in the configuration shown in FIG. 16, the elbow 24e can easily absorb the misalignment, and the above-mentioned wing movement does not hinder the elbow 24e when the lid part 25 is opened or closed, making it easy to open and close the lid part 25.

In the above embodiment, the first condenser 3 and the second condenser 4 are also configured as two condensers for condensing the pyrolysis gas generated in the pyrolysis furnace. However, the number of condensers is not limited to two, and may be one or three or more. The water trap 60 is provided upstream of the condenser (first condenser), and the off-gas pipe 6c is provided in the most downstream condenser, as in the above embodiment.

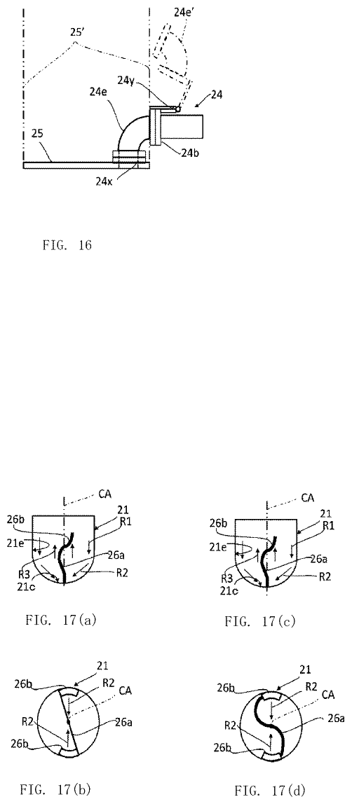

In the above embodiment, the lower edge 26a and the rising portion 26b of the blade portion 26 are formed by the plate-like member 26c that is linear in plan view, but this is not limited to this and may be, for example, as shown in FIG. 17

In the embodiment shown in FIG. 17(a)(b), only the rising portion 26b of the blade part 26 is formed in a spiral shape with respect to the central axis CA (located at the position of the shaft 27) which is the formation axis of the annular surface 21e (the shaft 27 and other members are omitted, but may be implemented as described above). In this case, when the blade part 26 rotates clockwise in the plan view, the material to be treated is forcibly sent from top to bottom in the direction of the arrow R1 in the part close to the annular surface 21e of the pyrolysis cauldron 21. As a result, the material to be treated is pressure-fed toward the bottom 21d, increasing its density and improving the heat transfer efficiency of pyrolysis. In the part in contact with the curved surface (bottom surface) 21c, the lower edge portion 26a of the blade portion 26 is formed linearly in the radial direction of the central axis CA, but the material to be treated that has passed the bottom surface 21c by the pressure-fed is gathered in the direction of the arrow R2 which is the direction close to the central axis CA, and is further raised in the direction of the arrow R3 along the central axis CA, so that the whole is stirred rationally.

FIGS. 17(c) and (d) show an embodiment in which both the rising portion 26b and the lower edge 26a of the blade part 26 are spiral. In this case, due to the spiral effect of the lower edge 26a, the material that has passed the bottom surface 21c is firmly gathered in the direction of the arrow R2, which is the direction approaching the central axis CA, and the overall stirring is more efficient. Note that if the rotation of the blade portion 21 around the central axis CA is reversed, the directions R1 to R3 are reversed, and clumping of the material can be mitigated.

The above-mentioned embodiments and modifications can be combined and implemented.

### INDUSTRIAL APPLICABILITY

The present invention can be used, for example, as an oil-liquefaction apparatus for chemically recycling waste plastics and waste tires, and an oil-liquefaction method using the device. The present invention also enables chemical recycling of composite materials such as LIMEX (registered trademark) that contain 50% or more of inorganic substances such as calcium carbonate.

### EXPLANATION OF SYMBOLS

1: oil-liquefaction apparatus,
2: pyrolysis furnace
3: 1^{st} a condenser.
4: 2^{nd} a condenser,
5: combustion device
6a: first gas pipe
6b: second gas pipe
6c: off-gas pipe
6c1: gas pipes
6c2: gas pipes
6c3: gradient pipe
6c4: branch pipe
6c5: combustion pipe
6c6: power generation pipe
6d1: first valve
6d2: second valve
6x: trap chamber
6y: lower valve
7: exhaust pipe
7a: first exhaust pipe
7b: second exhaust pipe
7c: third exhaust pipe
7d: fourth exhaust pipe
7x: valve
21: pyrolysis cauldron
21a: cylindrical middle part.
21b: lower and
21c: bottom curved surface,
21d: bottom part.
21e: annual inner surface,
21f: outlet
21x: line segment
21y: straight line segment
22: beating furnace.
22a: exhaust port
22b: exhaust tower
23: stirring device
23a: shaft portion
23b; drive unit
24: discharge section
24a, 24b: detachable connecting portion
24e: elbow
24x: discharge outlet
24y: hinge
25: s lid pant
25b: thermocouple
25z: inlet.
26: blade part.
26a: lower edge port
26b: rising portion
26b1; upper end
26c: plate-like member
26e: upper edge
26e1: straight portion
26e2: inclined portion
26f: protruding portion
27 shaft
27a: lower shaft part
27b: upper shaft part
27c: connecting part
28: shaft holder
29: lifting mechanism
31: first condenser portion
32: first storage tank
32a: outlet
33: heat retaining member
34: exterior member
35: heater
37: cooling water tank.
41: a second condensing section
42; second storage tank
42a: outlet
47: cooling water tank
40: power generation unit
41: hydrogenation device
43: power generation device
51: burner unit
52: air supply unit
53: venturi
54: plug
60: water trap
61: main body
61a: storage section
62: inlet pipe
63: outlet pipe
63a: outlet
64: water contact section
65: gas supply device
65a: bottom
65b: side portion
65c: rear portion
65d: inlet
65c: rear slit
65f: front edge
65g: upper opening
66: jet supply section
67: pump
68: jet outlet
69: remover
69a: annular portion
69b: remover
70: bypass path
70a: gradient pipe
71: inlet side three-way valve
72: outlet side three-way valve
73: horizontal pipe
C1, C2: cooling water
CA: central axis
M: material
G1: pyrolysis gas
G2: gas produced in the first condenser
G3: off-gassing
H1: exhaust gas from the heating furnace
H2: exhaust gas to gas piping
H3: waste beat gas to the first condenser
F1: material filling line
F2: boiling liquid level
L1: upper limit of adhesion generation
L2: sliding line

1. An oil-liquefaction apparatus which comprises:
a pyrolysis furnace for pyrolyzing a synthetic resin-containing material that is input, and a condenser for condensing a pyrolysis gas generated in the pyrolysis furnace,
said pyrolysis furnace including at least a pyrolysis cauldron for holding the material to be treated, a heating furnace for heating the pyrolysis cauldron from the outside, a stirring device for stirring the material within the pyrolysis cauldron, and a discharge section for discharging pyrolysis gas generated in the pyrolysis cauldron to the condenser,
said pyrolysis cauldron has a bottom portion having a bottom surface formed by a body of revolution of a line segment whose center is convex downward, a substantially cylindrical middle portion having an inner annular surface continuous with the bottom surface, and a lid portion covering an upper portion of the middle portion,
said heating furnace heats the bottom and at least a lower portion of the middle part of the pyrolysis cauldron,
said stirring device has a shaft portion that rotates at the center of the pyrolysis cauldron and a blade portion attached to the shaft portion, and the blade portion being brought into sliding contact with the bottom surface and the annular surface by the rotation of the shaft portion, and
said heating furnace has a combustion device and an off-gas piping for directing the off-gas passing through the condenser to the combustion device as a combustion fuel, and
which further comprises:
an air supplier which supplies combustion air to the combustion apparatus, the air piping of the air supplier being connected to the combustion apparatus through a venturi, and the off-gas piping being further connected to the venturi to supply the off-gas to the combustion apparatus by suction.

2. The oil-liquefaction apparatus according to claim 1, which further comprise a tank located below the condenser which is heated from the outside by the exhaust gas from said heating furnace.

3-4. (canceled)

5. The oil-liquefaction apparatus according to claim 1, in which said off-gas piping has an upward gradient from the condenser side to the combustion device side, and which further comprises: a trap chamber for reducing the flow velocity of the off-gas is provided near the combustion device.

6. An oil-liquefaction apparatus, which comprises:
a pyrolysis furnace for pyrolyzing a synthetic resin-containing material that is input, and a condenser for condensing a pyrolysis gas generated in the pyrolysis furnace,
said pyrolysis furnace including at least a pyrolysis cauldron for holding the material to be treated, a heating furnace for heating the pyrolysis cauldron from the outside, a stirring device for stirring the material within the pyrolysis cauldron, and a discharge section for discharging pyrolysis gas generated in the pyrolysis cauldron to the condenser,
said pyrolysis cauldron has a bottom portion having a bottom surface formed by a body of revolution of a line segment whose center is convex downward, a substantially cylindrical middle portion having an inner annular surface continuous with the bottom surface, and a lid portion covering an upper portion of the middle portion,
said heating furnace heats the bottom and at least a lower portion of the middle part of the pyrolysis cauldron,
said stirring device has a shaft portion that rotates at the center of the pyrolysis cauldron and a blade portion attached to the shaft portion, and the blade portion being brought into sliding contact with the bottom surface and the annular surface by the rotation of the shaft portion, and
in which a drive unit of said stirring device is provided in the lid of the pyrolysis vessel, and the lid is capable of being opened and closed with respect to the intermediate section, said shaft portion is divided into a lower shaft part to which the blade is attached and an upper shaft part that can be inserted and fitted into the lower shaft part and is connected to the drive unit, and said intermediate section has a shaft holding section that rotatably holds the lower shaft part.

7. The oil-liquefaction apparatus according to claim 1, in which a discharge port to the discharge unit is provided in said lid, and the discharge port is disposed above a boiling liquid level at which the material to be treated boils due to heating.

8. The oil-liquefaction apparatus according to claim 6, in which said discharge unit has an elbow that connects the discharge port to a connecting section that is positioned outside the movement path of the lid section when the lid section is opened or closed, and the elbow is capable of swinging and moving to the upper part of the connecting section by a hinge provided at an upper part where the elbow and the connecting section are continuous.

9. An oil-liquefaction apparatus, which comprises:
a pyrolysis furnace for pyrolyzing a synthetic resin-containing material that is input, and a condenser for condensing a pyrolysis gas generated in the pyrolysis furnace,
said pyrolysis furnace including at least a pyrolysis cauldron for holding the material to be treated, a heating furnace for heating the pyrolysis cauldron from the outside, a stirring device for stirring the material within the pyrolysis cauldron, and a discharge section for discharging pyrolysis gas generated in the pyrolysis cauldron to the condenser,
said pyrolysis cauldron has a bottom portion having a bottom surface formed by a body of revolution of a line segment whose center is convex downward, a substantially cylindrical middle portion having an inner annular surface continuous with the bottom surface, and a lid portion covering an upper portion of the middle portion,
said heating furnace heats the bottom and at least a lower portion of the middle part of the pyrolysis cauldron,
said stirring device has a shaft portion that rotates at the center of the pyrolysis cauldron and a blade portion attached to the shaft portion, and the blade portion being brought into sliding contact with the bottom surface and the annular surface by the rotation of the shaft portion, and
in which a water trap is interposed in the middle of the discharge unit, and the water trap has an inlet pipe for introducing the pyrolysis gas, an outlet pipe for leading the pyrolysis gas that has passed through the water trap to the condenser, and a water contact section for bringing water into contact with the pyrolysis gas.

10. The oil-liquefaction apparatus according to claim 9, in which said inlet pipe is provided with a jet supply section for supplying the pyrolysis gas to the contact section and for supplying a jet of water to the water contact section, and said outlet pipe discharges the pyrolysis gas that has passed through the water contact portion to the outside.

11. The oil-liquefaction apparatus according to claim 10, in which said water contact section has a gas supplying tool including a bottom section for receiving water, an open section for supplying the water from the jet supplying section toward the bottom section in a jet flow, and a side wall section for covering the sides other than the open section so that the pyrolysis gas does not pass through, and said water supplied in the jet flow flows down from at least the open section side of the bottom section toward the outlet pipe.

12. The oil-liquefaction apparatus according to claim 9, in which said water trap has a water storage section, the inlet pipe supplies the pyrolysis gas to a nozzle located in the water stored in the storage section and ejects the pyrolysis gas from the nozzle to form the water contact section, and the outlet pipe, located above the water surface in the storage section, ejects the pyrolysis gas that has passed through the water contact section to the outside.

13. The oil-liquefaction apparatus claim 9, in which said introduction pipe is heated from the outside by exhaust gas from the heating furnace.

14. The oil-liquefaction apparatus claim 9, which further comprises a bypass path that can be switched to bypass the water trap, between the inlet pipe and the outlet pipe, and said bypass path has a horizontal or a gradient that descends toward the pyrolysis tank side.

15. The oil-liquefaction apparatus claim 1, in which said material to be treated includes a composite material containing 50% or more of inorganic matter, waste plastic, or waste tires.

16. The oil-liquefaction apparatus claim 1, in which said condenser includes a first condenser for condensing the pyrolysis gas generated in the pyrolysis furnace and a second condenser for condensing the gas generated in the first condenser, and the length of the condensation portion of the second condenser is longer than the length of the condensation portion of the first condenser.

17-19. (canceled)

20. The oil-liquefaction apparatus claim 1, in which said blade portion has a raised portion that is in sliding contact with the annular surface and is formed in a spiral direction about an axis of the annular surface.
